(19) United States
(12) Patent Application Publication
(10) Pub. No.: US 2013/0188611 A1
(43) Pub. Date: Jul. 25, 2013

(54) SUBFRAME CONSTRAINTS FOR COORDINATED MULTI-POINT COMMUNICATION

(71) Applicant: QUALCOMM Incorporated, San Diego, CA (US)

(72) Inventors: Tao Luo, San Diego, CA (US); Wanshi Chen, San Diego, CA (US); Yongbin Wei, San Diego, CA (US); Stefan Geirhofer, San Diego, CA (US); Peter Gaal, San Diego, CA (US)

(73) Assignee: QUALCOMM INCORPORATED, San Diego, CA (US)

(21) Appl. No.: 13/746,084

(22) Filed: Jan. 21, 2013

Related U.S. Application Data
(60) Provisional application No. 61/589,779, filed on Jan. 23, 2012.

(51) Int. Cl. H04W 24/02

(52) U.S. Cl. CPC H04W 24/02
USPC 370/336

(57) ABSTRACT

Certain aspects of the present disclosure relate to methods, and corresponding apparatus and program products, for wireless communication involving coordinated multipoint (CoMP) operation that involves dynamic switching between multiple transmission points that serve a user equipment (UE).

### CLAIM OF PRIORITY UNDER 35 U.S.C. §119

This application claims benefit of U.S. Provisional Patent Application No. 61/589,779, filed Jan. 23, 2012, entitled “SUBFRAME CONSTRAINTS FOR COORDINATED MULTI-POINT COMMUNICATION” which is herein incorporated by reference in its entirety.

### FIELD

Certain aspects of the disclosure generally relate to wireless communications and, more particularly, to techniques for improved timing estimation under Coordinated Multi-Point (CoMP) communication.

### BACKGROUND

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may observe interference due to transmissions from neighbor base stations. On the uplink, a transmission from the UE may cause interference to transmissions from other UEs communicating with the neighbor base stations. The interference may degrade performance on both the downlink and uplink.

### SUMMARY

In an aspect of the disclosure, a method for wireless communications is provided. The method generally includes participating in coordinated multipoint (CoMP) operations with a plurality of transmission points, wherein dynamic switching between sets of one or more serving transmission points is subject to one or more constraints, determining, based on the constraints, a first interval during which dynamic switching from a first set of at least one serving transmission point to a second set of at least one serving transmission point is prohibited, the first interval spanning multiple subframes in which the first serving transmission point provides reference signals (RS), and performing timing estimation based on reference signals (RSs) provided by the first set of serving transmission points over multiple subframes in the first interval

Certain aspects of the present disclosure provide a method for wireless communications by a user equipment (UE). The method generally includes determining, based on one or more constraints, a first interval during which dynamic switching from a first set of at least one serving transmission point to a second set of at least one serving transmission point is prohibited, the first interval spanning multiple subframes in which the first serving transmission point provides reference signals (RS) to a user equipment (UE) and dynamically switching from the first set of at least one serving transmission point serving the UE to the second set of at least one transmission point serving the UE only after the first interval.

Certain aspects of the present disclosure provide an apparatus for wireless communications. The apparatus generally includes means for participating in coordinated multipoint (CoMP) operations with a plurality of transmission points, wherein dynamic switching between sets of one or more serving transmission points is subject to one or more constraints, means for determining, based on the constraints, a first interval during which dynamic switching from a first set of at least one serving transmission point to a second set of at least one serving transmission point is prohibited, the first interval spanning multiple subframes in which the first serving transmission point provides reference signals (RS), and means for performing timing estimation based on reference signals (RSs) provided by the first set of serving transmission points over multiple subframes in the first interval; and a memory coupled with the at least one processor.

Certain aspects of the present disclosure provide an apparatus for wireless communications. The apparatus generally includes means for determining, based on one or more constraints, a first interval during which dynamic switching from a first set of at least one serving transmission point to a second set of at least one serving transmission point is prohibited, the first interval spanning multiple subframes in which the first serving transmission point provides reference signals (RS) to a user equipment (UE) and means for dynamically switching from the first set of at least one serving transmission point serving the UE to the second set of at least one transmission point serving the UE only after the first interval.

Certain aspects of the present disclosure provide an apparatus for wireless communications. The apparatus generally includes at least one processor configured to participate in coordinated multipoint (CoMP) operations with a plurality of transmission points, wherein dynamic switching between sets of one or more serving transmission points is subject to one or more constraints, determine, based on the constraints, a first interval during which dynamic switching from a first set of at least one serving transmission point to a second set of at least one serving transmission point is prohibited, the first interval spanning multiple subframes in which the first serving transmission point provides reference signals (RS), and perform timing estimation based on reference signals (RSs) provided by the first set of serving transmission points over multiple subframes in the first interval; and a memory coupled with the at least one processor.

Certain aspects of the present disclosure provide an apparatus for wireless communications. The apparatus generally includes at least one processor configured to determine, based on one or more constraints, a first interval during which dynamic switching from a first set of at least one serving transmission point to a second set of at least one serving transmission point is prohibited, the first interval spanning multiple subframes in which the first serving transmission point provides reference signals (RS) to a user equipment (UE) and dynamically switch from the first set of at least one serving transmission point serving the UE to the second set of at least one transmission point serving the UE only after the first interval; and a memory coupled with the at least one processor

Certain aspects of the present disclosure provide a computer program product comprising a computer readable medium having instructions stored thereon. The instructions are generally executable by one or more processors for participating in coordinated multipoint (CoMP) operations with a plurality of transmission points, wherein dynamic switching between sets of one or more serving transmission points is subject to one or more constraints, determining, based on the constraints, a first interval during which dynamic switching from a first set of at least one serving transmission point to a second set of at least one serving transmission point is prohibited, the first interval spanning multiple subframes in which the first serving transmission point provides reference signals (RS), and performing timing estimation based on reference signals (RSs) provided by the first set of serving transmission points over multiple subframes in the first interval.

Certain aspects of the present disclosure provide a computer program product comprising a computer readable medium having instructions stored thereon. The instructions are generally executable by one or more processors for determining, based on one or more constraints, a first interval during which dynamic switching from a first set of at least one serving transmission point to a second set of at least one serving transmission point is prohibited, the first interval spanning multiple subframes in which the first serving transmission point provides reference signals (RS) to a user equipment (UE), and dynamically switching from the first set of at least one serving transmission point serving the UE to the second set of at least one transmission point serving the UE only after the first interval

Various aspects and features of the disclosure are described in further detail below.

### BRIEF DESCRIPTION OF THE DRAWINGS

FIG. 1 is a block diagram conceptually illustrating an example of a wireless communications network in accordance with certain aspects of the present disclosure.

FIG. 2 is a block diagram conceptually illustrating an example of a frame structure in a wireless communications network in accordance with certain aspects of the present disclosure.

FIG. 2A shows an example format for the uplink in Long Term Evolution (LTE) in accordance with certain aspects of the present disclosure.

FIG. 3 shows a block diagram conceptually illustrating an example of a Node B in communication with a user equipment device (UE) in a wireless communications network in accordance with certain aspects of the present disclosure.

FIG. 4 illustrates an example heterogeneous network (HetNet) in accordance with certain aspects of the present disclosure.

FIG. 5 illustrates example resource partitioning in a heterogeneous network in accordance with certain aspects of the present disclosure.

FIG. 6 illustrates example cooperative partitioning of subframes in a heterogeneous network in accordance with certain aspects of the present disclosure.

FIG. 7 illustrates example CoMP multi-point switching operations by a UE in accordance with this disclosure.

FIG. 8 illustrates example CoMP multi-point switching operations by a controlling eNB in accordance with this disclosure.

### DETAILED DESCRIPTION

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

### Example Wireless Network

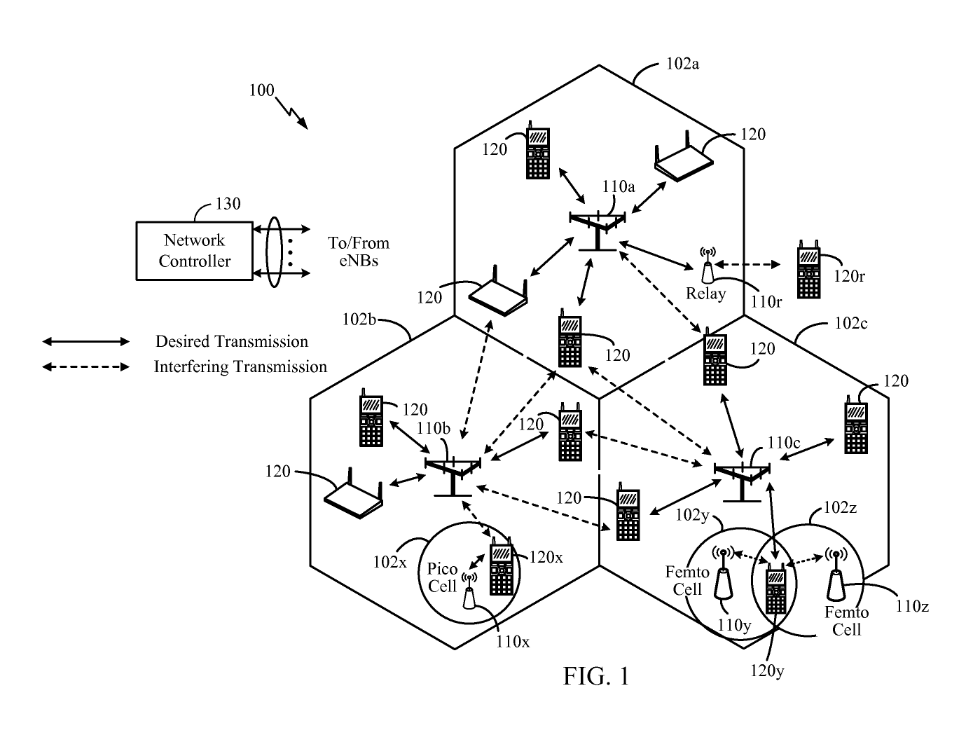

FIG. 1 shows a wireless communication network 100, which may be an LTE network. The wireless network 100 may include a number of evolved Node Bs (eNBs) 110 and other network entities. An eNB may be a station that communicates with user equipment devices (UEs) and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB (i.e., a macro base station). An eNB for a pico cell may be referred to as a pico eNB (i.e., a pico base station). An eNB for a femto cell may be referred to as a femto eNB (i.e., a femto base station) or a home eNB. In the example shown in FIG. 1, eNBs 110a, 110b, and 110c may be macro eNBs for macro cells 102a, 102b, and 102c, respectively. eNB 110x may be a pico eNB for a pico cell 102x. eNBs 110y and 110z may be femto eNBs for femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with eNB 110a and a UE 120r in order to facilitate communication between eNB 110a and UE 120r. A relay station may also be referred to as a relay eNB, a relay, etc.

The wireless network 100 may be a heterogeneous network (HetNet) that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 watts) whereas pico eNBs, femto eNBs, and relays may have a lower transmit power level (e.g., 1 watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a terminal, a mobile station, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a tablet, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB. For certain aspects, the UE may comprise an LTE Release 10 UE.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz, and there may be 1, 2, 4, 8, or 16 subbands for system bandwidth of 1.25, 2.5, 5, 10, or 20 MHz, respectively.

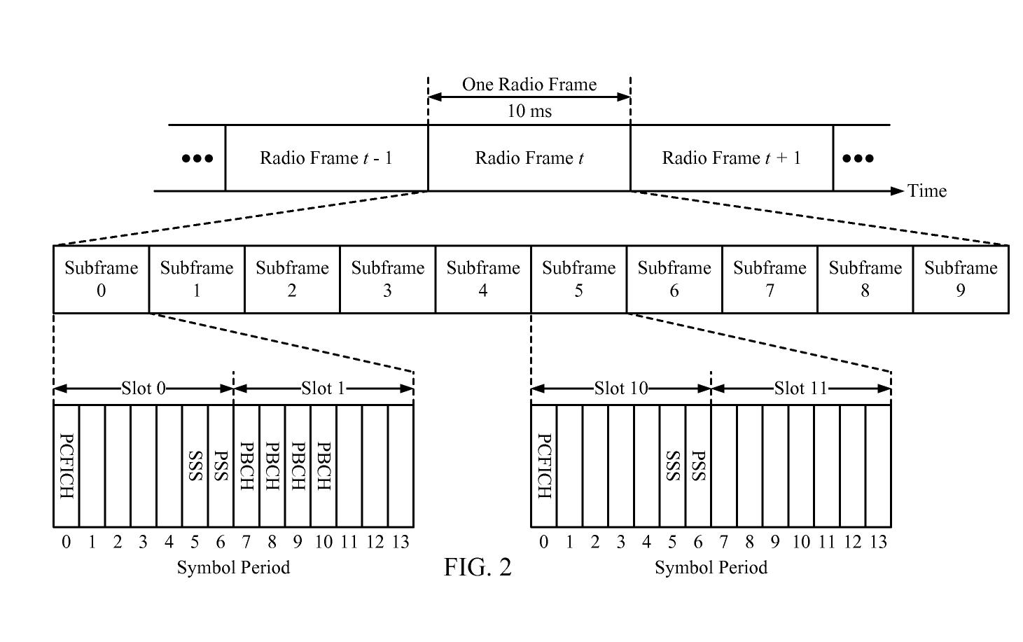

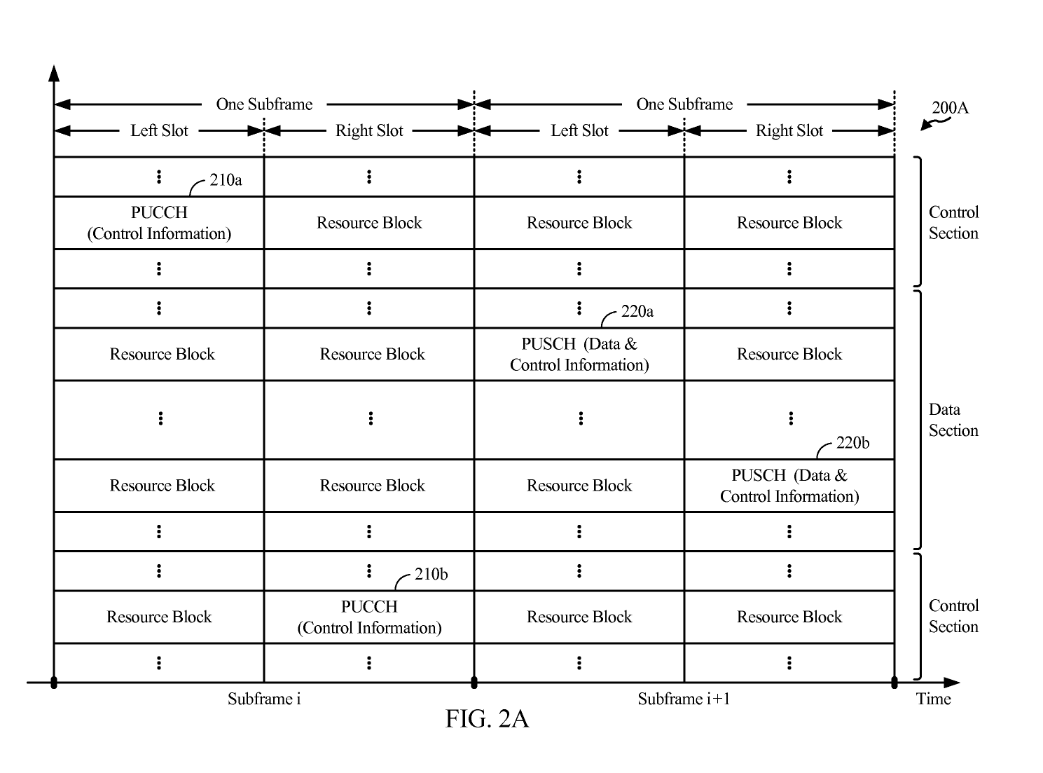

FIG. 2 shows a frame structure used in LTE. The transmission timeline for the downlink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., L=7 symbol periods for a normal cyclic prefix (as shown in FIG. 2) or L=6 symbol periods for an extended cyclic prefix. The 2L symbol periods in each subframe may be assigned indices of 0 through 2L−1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe, as shown in FIG. 2. The PCFICH may convey the number of symbol periods (M) used for control channels, where M may be equal to 1, 2, or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe (not shown in FIG. 2). The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink. The various signals and channels in LTE are described in 3GPP TS 36.211, entitled “Evolved Universal Terrestrial Radio Access (E-UTRA); Physical Channels and Modulation,” which is publicly available.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 32, or 64 REGs, which may be selected from the available REGs, in the first M symbol periods. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

FIG. 2A shows an exemplary format 200A for the uplink in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 2A results in the data section including contiguous subcarriers, which may allow a single UE to be assigned all of the contiguous subcarriers in the data section.

A UE may be assigned resource blocks in the control section to transmit control information to an eNB. The UE may also be assigned resource blocks in the data section to transmit data to the eNB. The UE may transmit control information in a Physical Uplink Control Channel (PUCCH) 210a, 210b on the assigned resource blocks in the control section. The UE may transmit only data or both data and control information in a Physical Uplink Shared Channel (PUSCH) 220a, 220b on the assigned resource blocks in the data section. An uplink transmission may span both slots of a subframe and may hop across frequency as shown in FIG. 2A.

A UE may be within the coverage of multiple eNBs. One of these eNBs may be selected to serve the UE. The serving eNB may be selected based on various criteria such as received power, pathloss, signal-to-noise ratio (SNR), etc.

A UE may operate in a dominant interference scenario in which the UE may observe high interference from one or more interfering eNBs. A dominant interference scenario may occur due to restricted association. For example, in FIG. 1, UE 120y may be close to femto eNB 110y and may have high received power for eNB 110y. However, UE 120y may not be able to access femto eNB 110y due to restricted association and may then connect to macro eNB 110c with lower received power (as shown in FIG. 1) or to femto eNB 110z also with lower received power (not shown in FIG. 1). UE 120y may then observe high interference from femto eNB 110y on the downlink and may also cause high interference to eNB 110y on the uplink.

A dominant interference scenario may also occur due to range extension, which is a scenario in which a UE connects to an eNB with lower pathloss and lower SNR among all eNBs detected by the UE. For example, in FIG. 1, UE 120x may detect macro eNB 110b and pico eNB 110x and may have lower received power for eNB 110x than eNB 110b. Nevertheless, it may be desirable for UE 120x to connect to pico eNB 110x if the pathloss for eNB 110x is lower than the pathloss for macro eNB 110b. This may result in less interference to the wireless network for a given data rate for UE 120x.

In an aspect, communication in a dominant interference scenario may be supported by having different eNBs operate on different frequency bands. A frequency band is a range of frequencies that may be used for communication and may be given by (i) a center frequency and a bandwidth or (ii) a lower frequency and an upper frequency. A frequency band may also be referred to as a band, a frequency channel, etc. The frequency bands for different eNBs may be selected such that a UE can communicate with a weaker eNB in a dominant interference scenario while allowing a strong eNB to communicate with its UEs. An eNB may be classified as a “weak” eNB or a “strong” eNB based on the received power of signals from the eNB received at a UE (and not based on the transmit power level of the eNB).

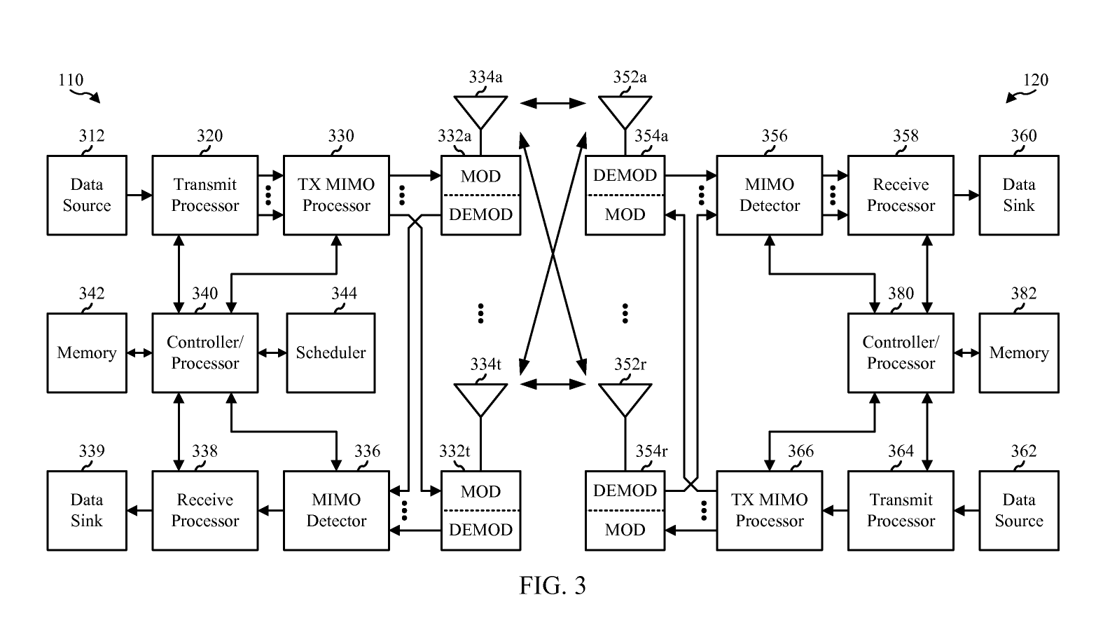

FIG. 3 is a block diagram of a design of a base station or an eNB 110 and a UE 120, which may be one of the base stations/eNBs and one of the UEs in FIG. 1. For a restricted association scenario, the eNB 110 may be macro eNB 110c in FIG. 1, and the UE 120 may be UE 120y. The eNB 110 may also be a base station of some other type. The eNB 110 may be equipped with T antennas 334a through 334t, and the UE 120 may be equipped with R antennas 352a through 352r, where in general T 1 and R≧1.

At the eNB 110, a transmit processor 320 may receive data from a data source 312 and control information from a controller/processor 340. The control information may be for the PBCH, PCFICH, PHICH, PDCCH, etc. The data may be for the PDSCH, etc. The transmit processor 320 may process (e.g., encode and symbol map) the data and control information to obtain data symbols and control symbols, respectively. The transmit processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide T output symbol streams to T modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. T downlink signals from modulators 332a through 332t may be transmitted via T antennas 334a through 334t, respectively.

At the UE 120, antennas 352a through 352r may receive the downlink signals from the eNB 110 and may provide received signals to demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all R demodulators 354a through 354r, perform MIMO detection on the received symbols, if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The transmit processor 364 may also generate reference symbols for a reference signal. The symbols from transmit processor 364 may be precoded by a TX MIMO processor 366 if applicable, further processed by modulators 354a through 354r (e.g., for SC-FDM, etc.), and transmitted to the eNB 110. At the eNB 110, the uplink signals from the UE 120 may be received by the antennas 334, processed by the demodulators 332, detected by a MIMO detector 336 if applicable, and further processed by a receive processor 338 to obtain decoded data and control information sent by the UE 120. The receive processor 338 may provide the decoded data to a data sink 339 and the decoded control information to the controller/processor 340.

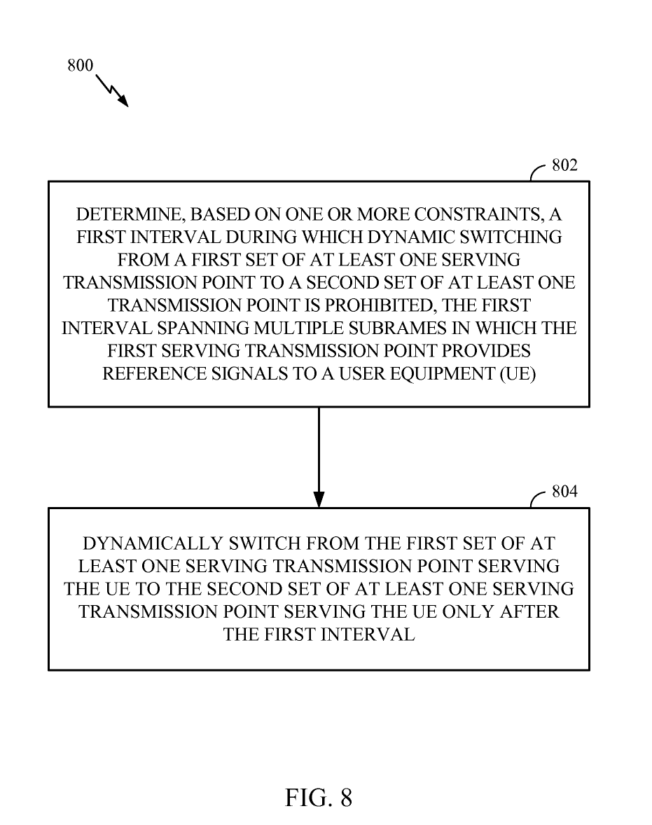

The controllers/processors 340 and 380 may direct the operation at the eNB 110 and the UE 120, respectively. The controller/processor 340, receive processor 338, and/or other processors and modules at the eNB 110 may perform or direct operations 800 in FIG. 8 and/or other processes for the techniques described herein. The memories 342 and 382 may store data and program codes for the eNB 110 and the UE 120, respectively. A scheduler 344 may schedule UEs for data transmission on the downlink and/or uplink.

### Example Resource Partitioning

Certain aspects of the present disclosure may be utilized in wireless networks that support enhanced inter-cell interference coordination (eICIC). According to eICIC, the base stations may negotiate with each other to coordinate resources in order to reduce or eliminate interference by the interfering cell giving up part of its resources. In accordance with this interference coordination, a UE may be able to access a serving cell even with severe interference by using resources yielded by the interfering cell.

Interference coordination may be used to particular advantage in heterogeneous networks that utilize base stations of different power classes (e.g., to create macro, femto, and pico cells).

For example, a femto cell with a closed access mode (i.e., in which only a member femto UE can access the cell) in the coverage area of an open macro cell may be able to create a “coverage hole” (in the femto cell's coverage area) for a macro cell by yielding resources and effectively removing interference. By negotiating for a femto cell to yield resources, the macro UE under the femto cell coverage area may still be able to access the UE's serving macro cell using these yielded resources.

In a radio access system using OFDM, such as Evolved Universal Terrestrial Radio Access Network (E-UTRAN), the yielded resources may be time based, frequency based, or a combination of both. When the coordinated resource partitioning is time based, the interfering cell may simply not use some of the subframes in the time domain. When the coordinated resource partitioning is frequency based, the interfering cell may yield subcarriers in the frequency domain. With a combination of both frequency and time, the interfering cell may yield frequency and time resources.

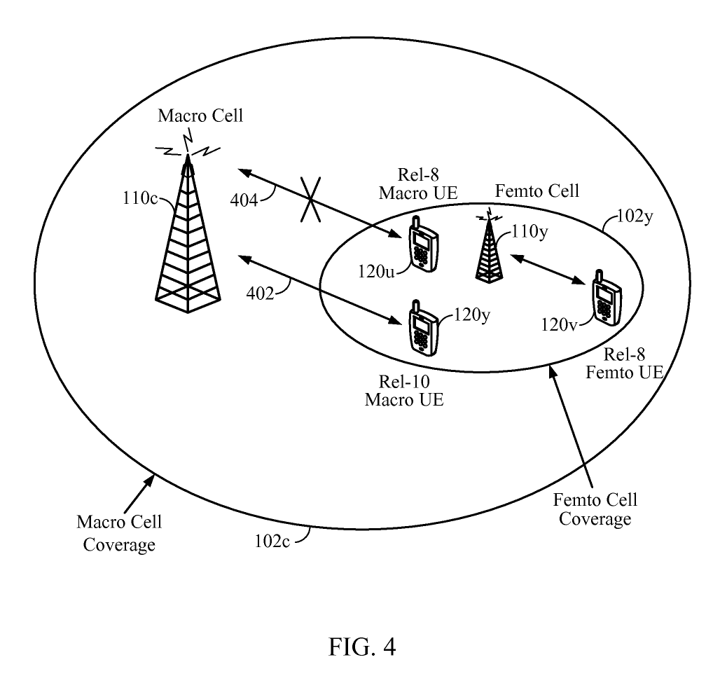

FIG. 4 illustrates an example scenario where eICIC may allow a macro UE 120y supporting eICIC (e.g., a Rel-10 macro UE as shown in FIG. 4) to access the macro cell 110c even when the macro UE 120y is experiencing severe interference from the femto cell y, as illustrated by the solid radio link 402. A legacy macro UE 120u (e.g., a Rel-8 macro UE as shown in FIG. 4) may not be able to access the macro cell 110c under severe interference from the femto cell 110y, as illustrated by the broken radio link 404. A femto UE 120v (e.g., a Rel-8 femto UE as shown in FIG. 4) may access the femto cell 110y without any interference problems from the macro cell 110c.

According to certain aspects, networks may support eICIC, where there may be different sets of partitioning information. A first of these sets may be referred to as Semi-static Resource Partitioning Information (SRPI). A second of these sets may be referred to as Adaptive Resource Partitioning Information (ARPI). As the name implies, SRPI typically does not change frequently, and SRPI may be sent to a UE so that the UE can use the resource partitioning information for the UE's own operations.

As an example, the resource partitioning may be implemented with 8 ms periodicity (8 subframes) or 40 ms periodicity (40 subframes). According to certain aspects, it may be assumed that frequency division duplexing (FDD) may also be applied such that frequency resources may also be partitioned. For communications via the downlink (e.g., from a cell node B to a UE), a partitioning pattern may be mapped to a known subframe (e.g., a first subframe of each radio frame that has a system frame number (SFN) value that is a multiple of an integer N, such as 4). Such a mapping may be applied in order to determine resource partitioning information (RPI) for a specific subframe. As an example, a subframe that is subject to coordinated resource partitioning (e.g., yielded by an interfering cell) for the downlink may be identified by an index:

Index_{SRPI}_{_{—}}_{DL}=(SFN*10+subframe number)mod 8

For the uplink, the SRPI mapping may be shifted, for example, by 4 ms. Thus, an example for the uplink may be:

Index_{SRPI}_{_{—}}_{UL}=(SFN*10+subframe number+4)mod 8

SRPI may use the following three values for each entry:

U (Use): this value indicates the subframe has been cleaned up from the dominant interference to be used by this cell (i.e., the main interfering cells do not use this subframe);

N (No Use): this value indicates the subframe shall not be used; and

X (Unknown): this value indicates the subframe is not statically partitioned. Details of resource usage negotiation between base stations are not known to the UE.

Another possible set of parameters for SRPI may be the following:

U (Use): this value indicates the subframe has been cleaned up from the dominant interference to be used by this cell (i.e., the main interfering cells do not use this subframe);

N (No Use): this value indicates the subframe shall not be used;

X (Unknown): this value indicates the subframe is not statically partitioned (and details of resource usage negotiation between base stations are not known to the UE); and

C (Common): this value may indicate all cells may use this subframe without resource partitioning. This subframe may be subject to interference, so that the base station may choose to use this subframe only for a UE that is not experiencing severe interference.

The serving cell's SRPI may be broadcasted over the air. In E-UTRAN, the SRPI of the serving cell may be sent in a master information block (MIB), or one of the system information blocks (SIBs). A predefined SRPI may be defined based on the characteristics of cells, e.g. macro cell, pico cell (with open access), and femto cell (with closed access). In such a case, encoding of SRPI in the system overhead message may result in more efficient broadcasting over the air.

The base station may also broadcast the neighbor cell's SRPI in one of the SIBs. For this, SRPI may be sent with its corresponding range of physical cell identities (PCIs).

ARPI may represent further resource partitioning information with the detailed information for the ‘X’ subframes in SRPI. As noted above, detailed information for the ‘X’ subframes is typically only known to the base stations, and a UE does not know it.

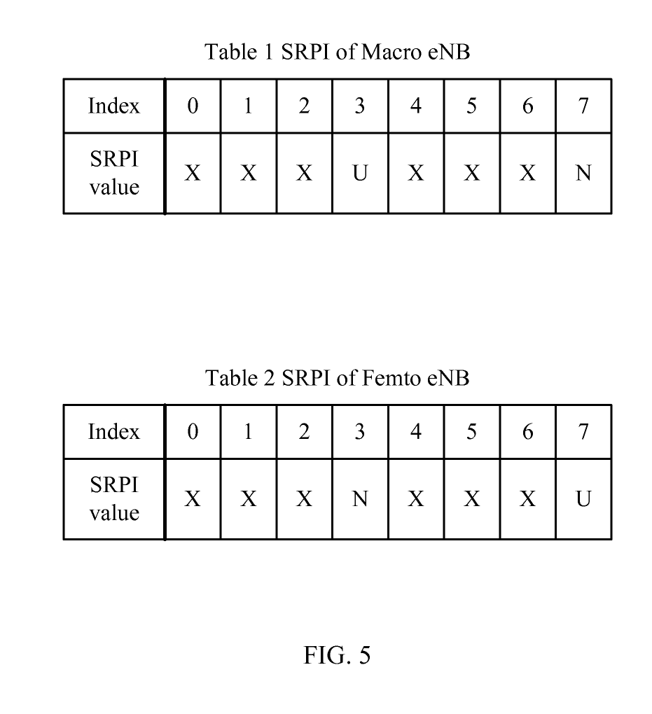

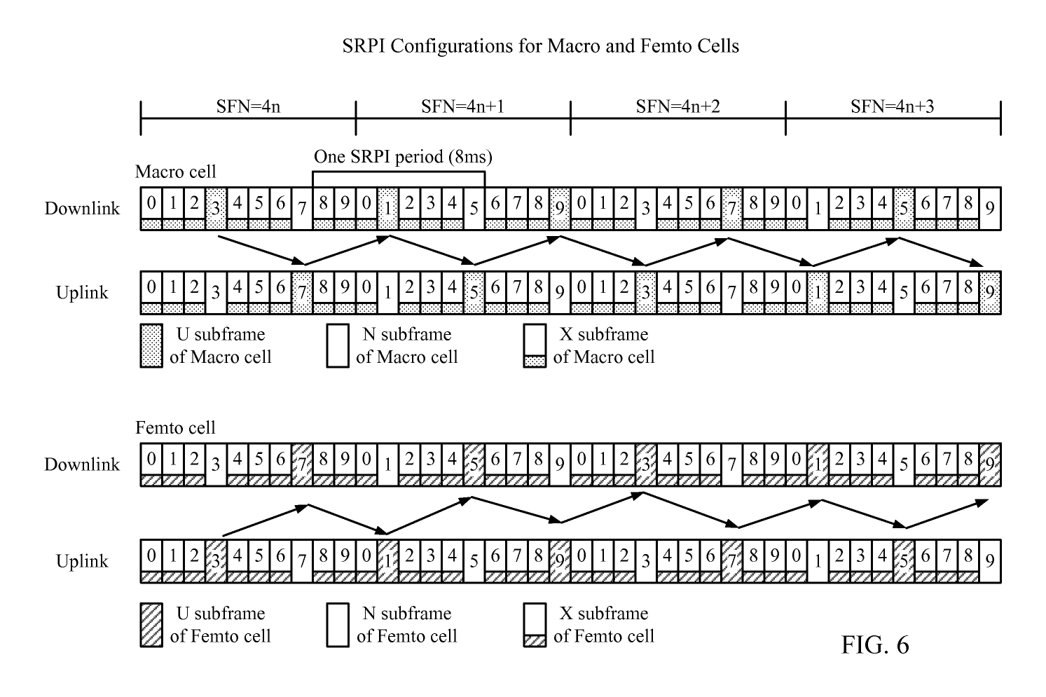

FIGS. 5 and 6 illustrate examples of SRPI assignment in the scenario with macro and femto cells. A U, N, X, or C subframe is a subframe corresponding to a U, N, X, or C SRPI assignment.

### Subframe Constraints For Dynamic Multi-Point Communication

Advanced wireless standards that govern wireless network coverage may specify that Coordinated multipoint transmission schemes (CoMP) be supported. CoMP refers to a network arrangement in which multiple base stations or transmission points coordinate transmissions to (DL CoMP) or receptions from (UL CoMP) one or more user equipments (UEs).

Such standards may define networks that can separately or jointly enable DL CoMP and UL CoMP for a UE. Furthermore, a variety of different CoMP arrangements are currently being used by certain networks.

For example, in joint-transmission CoMP (a form of DL CoMP), multiple eNBs transmit the same data to a UE when it is in a region where the signal strengths of the multiple eNBs are comparable. In similar fashion, joint-reception CoMP (a form of UL CoMP) involves multiple eNBs receiving the transmissions of a single UE, with the stronger of the multiple signals subsequently being identified for use. The multiple signals may also be combined by the multiple eNBs and processed jointly.

Another CoMP method involves coordinated beamforming between neighboring cells. In accordance with this method, an eNB transmits to a UE using beams that are chosen to reduce interference to other UEs. Likewise, scheduling decisions may be made by the eNB by taking interference to other UEs into account.

In a fourth scheme known as dynamic point(s) selection, the network changes the transmission point involved in transmitting and receiving data to and from a UE. The system is configured to switch transmission points as often as every subframe. In this arrangement, channel conditions and the geographic location of the UE are primary factors in determining whether a switch occurs.

The rapid switching of UE transmission points in dynamic point switching will pose challenges involving UE timing estimation because, without control over the frequency of switching, UEs may no longer perform timing estimation across multiple subframes. This may lead to timing misalignment between a transmission point and a UE, thereby leading to diminished system performance.

A solution proposed in accordance with the present disclosure is to impose constraints on the frequency of switching in such a way that the constraints can be recognized and relied upon by UEs.

The UEs may determine, based on the constraints, a first interval during which the system is not allowed to order a dynamic switch from one or more serving transmission points to a different transmission point or set of transmission points. This first interval may span multiple subframes in which one or more of the first serving transmission points provides reference signals (RS). By determining the constraints, the UE may perform timing estimation based on reference signals (RSs) provided by the first set of serving transmission points over multiple subframes in the first interval.

CoMP dynamic point switching arrangements may be incorporated into homogeneous networks as well as heterogeneous networks (HetNets). In the context of heterogeneous networks, CoMP often involves low power node transmission points which may be referred to as remote radio heads. Furthermore, the communication medium used by the nodes involved in CoMP to coordinate communications may be X2 or fiber-optic cable. Fiber-optic cable connections have the advantage of minimal latency and maximum bandwidth.

In more traditional network arrangements, such as those standardized in LTE Release 8, 9 and 10, time tracking has been based on cell specific reference signals (also known as common reference signals or CRS).

In these arrangements, CRS is present in all subframes and is carried across the entire system bandwidth. In a typical subframe, CRS is present within both subframe segments reserved for control information and segments reserved for data. The frequent transmission of CRS in all subframes contributes to reliable time tracking, and enables timing synchronization procedures that utilize refinement of an initial timing estimate during two or more subframes for improved performance.

However, in some scenarios, CRS time tracking may either become impossible, or impractical. For example, LTE Release 11 will define additional carrier types, which may not carry CRS. Thus, CRS may not always be present on carriers in all subframes, and in some cases, will not be present in any subframes.

Additionally, certain scenarios will simply not be compatible with synchronization based on CRS. CoMP may be one such arrangement. In certain CoMP modes of operation, control and data information may be concurrently transmitted to a single UE from different transmission points.

According to certain aspects, this decoupling of control and data transmissions may be transparent to the UE and the data transmission to the UE may be facilitated by UE-specific demodulation reference signals (DM-RS). A UE, therefore, may not be able to derive timing information for the data transmission from the CRS as the transmission of the CRS may be originating from a different transmission point than the data transmission.

An alternative to time tracking based on CRS may therefore needed for networks that operate in accordance with the aforementioned aspects. Examples of some of the new approaches to time tracking include UE-RS (which stands for UE specific Reference Signal, and is also known as DM-RS) and CSI-RS (Channel State Information Reference Signal).

However, these new time tracking approaches may not involve reference signal broadcasts occurring with the same regularity with which they occurred under CRS. Moreover, the reference signals may not be transmitted over the entire system bandwidth as may be the case for the CRS. The ability to successfully time track in this new environment may critically impact PDSCH and ePDCCH performance.

Advanced standards may further introduce enhanced Physical Downlink control Channels (ePDCCH). Unlike legacy PDCCH, which is transmitted only in the first several symbols of a subframe, ePDCCH may use all symbols of a subframe to send control information in a manner similar to PDSCH. Furthermore, unlike PDSCH, which may frequently span a relatively large bandwidth (depending on its allocation in a certain subframe), one ePDCCH may only consume one or a very limited number of resource blocks (RBs).

In LTE Releases 8, 9 and 10, both periodic and aperiodic channel state information (CSI) feedback is supported. Periodic CSI reporting involves a UE transmitting a report of channel conditions with a predetermined timeline (e.g., at an assigned interval and subframe offset). In contrast, aperiodic CSI may involve the transmission of a one-time report triggered through a grant on the control channel.

In LTE, both frequency division duplex (FDD) and time division duplex (TDD) systems are supported. FDD involves a downlink frequency being paired to an UL frequency. In contrast, TDD involves one frequency being shared for downlink and uplink. Additionally, TDD supports up to 7 downlink/uplink subframe configurations.

In TDD arrangements, one UL subframe may be scheduled to provide ACK/NAK (Acknowledge-Negative Acknowledge) feedback information related to a group of multiple past DL subframe transmissions. Under this type of arrangement, the set of DL subframes associated with an UL subframe ACK/NAK feedback is often called the DL subframe bundling window. Multiple ACK/NAK feedback modes are possible under such an arrangement. In ACK/NAK bundling, ACK/NAKs for multiple DL subframes may be bundled using a logical XOR operation in order to reduce ACK/NAK feedback overhead. However, this has the negative effect of DL throughput loss.

Another arrangement, known as ACK/NAK multiplexing, enables ACK/NAKs for multiple DL subframes to be explicitly transmitted. This has the effect of large overhead, but is good for DL performance.

UEs associated with edge regions that are roughly the same distance from two transmission points may benefit from the utilization of CoMP schemes. However, these UEs are most likely to be configured for ACK/NACK bundling or ACK/NACK feedback. In TDD systems, for feedback modes such as ACK/NAK bundling, it is desirable to have PDSCH decoding performance that is correlated with timing estimation for the DL transmissions within the same bundling window. Without such correlation, significant DL throughput loss may occur. For this reason, dynamic switching within the DL subframe bundling window is not desirable, as such switching may result in different decoding performance across subframes.

The limitation of not allowing for a per-subframe switching of transmission points may not be problematic because it may often not be necessary to have dynamic switching occur with a frequency close to the maximum possible switching frequency of the system (switching each subframe). Because channel state information (CSI) feedback from a UE is typically transmitted only every few subframes, dynamic switching to exploit channel conditions in excess of this scheduling rate may not be needed.

The issue may be the same with respect to load conditions for a cell. Because load conditions are measured less often than once per subframe, dynamic switching to achieve load balancing among transmission points is unwarranted if it occurs in excess of the load measuring rate. Also, load conditions may generally not change very much from one subframe to the other due to traffic characteristics.

For these reasons, it may be beneficial to subject dynamic switching of the set of serving cells for a UE to some constraints. In accordance with aspects of this disclosure, the wireless network may assign constraint intervals during which the network is forbidden from commanding a transmission point switch for a particular UE. The constraints may be established in a manner such that no UE can be switched more than once every two subframes. Moreover, a UE may be configured to recognize these restrictions and engage in timing estimation processes that are optimized in light of the restrictions.

In accordance with one embodiment, the restrictions may be implemented within a wireless communications network by assigning constraint intervals to each transmission point in a set of transmission points controlled by a central eNB. The interval corresponding to each transmission point may be at least 2 subframes in duration, and may be of different or common length as compared to other constraint intervals used in the network.

Alternatively, the constraint intervals may be defined on the basis of frames, each of which comprises a pre-established number of subframes known throughout the system. Throughout the constraint interval, the transmission point or set of multiple transmission points associated with the constraint interval may not change from the perspective of a specific UE. Only following the end of the constraint interval may the UE be switched to a different serving transmission point.

In accordance with this disclosure, a UE may be configured so that, following the end of the constraint interval, it abandons previous timing estimates established during the lapsed interval. The UE then reinitializes the timing estimation process by commencing new timing estimation based on reference signals (RS) provided by the current set of cells. Furthermore, it may ascertain a second constraint interval and start a counter that will enable it to recognize the expiration of the second interval.

In embodiments in which more than one transmission point at a time serves a single UE, the system may be configured to assign a constraint length indexed to the combination that identifies the specific pair or group of transmission points.

In an aspect, constraint intervals may be communicated and ascertained without reference to a transmission point identity. Signaling to the UE may be performed on a UE-specific basis. For example, constraint intervals may be signalled to the UE by the serving transmission point.

Additionally, the constraints that define the interval may be indexed to, or based on, the Channel State Information reporting schedule assigned to a UE. Where TDD is in use, the constraint interval may be determined by the number of ACK/NACK subframes included in the ACK/NACK bundles being transmitted by the UE. A constraint interval may also be tied to the uplink or downlink subframe configuration. As an example, subframe constraint intervals may be set to 5 ms when a DL/UL subframe configuration is 0/1/2/6, and to 10 ms for configurations 3/4/5.

Regardless of the mechanism used for identifying or communicating constraint intervals, these intervals may be altered at any time with respect to the entire system, or, alternatively, may even be alterable with respect to individual UEs or groups of UEs. Additionally, the system may be configured to apply constraint intervals only under certain circumstances. For example, a system may be designed to only apply constraints intervals when the assigned PDSCH bandwidth is below an identified threshold.

Subframe constraints may enable time tracking related operations to be greatly enhanced. When an initial constraint interval ends, a UE may expect that a switch has occurred, even though a switch may not necessarily have been required. Thus, at the end of the initial constraint interval, the UE may be configured to abandon past timing estimation that has been done based on subframes falling within the expired constraint interval. The UE may then immediately restart a subframe counter, ascertain a second constraint interval, and commence new timing estimation based on reference signals received in the subframe coinciding with the start of the counter.

During subsequent subframes received during the new constraint interval, the UE may improve time estimation performance by refining previous timing estimates in light of additional reference signals.

In accordance with an additional embodiment, during the second subframe following switching, as well as in subsequent subframes, the UE may update its Fast Fourier Transform (FFT) timing to better align with the actual downlink reception for the serving cell(s) in order to minimize inter-symbol interference (ISI). FFT timing adjustment is impractical without subframe constraint intervals, because these adjustments require buffering of all data in a subframe before performing an FFT.

Without the use of subframe constraint intervals, such buffering may have a dramatic negative impact on DL processing time, and would make it difficult to meet Hybrid Automatic Retransmission (H-ARQ) timing requirements. In this way, the first subframe carries out functions that, to subsequent subframes, are similar to those of a preamble.

Additional embodiments may provide additional adaptations to provide enhanced performance. For example, if performance is heavily compromised in the first subframe of a new constraint interval, an eNB which controls the serving transmission point may pick a more conservative modulation and coding scheme (MCS) to ensure a certain H-ARQ termination target. The adjustment of the modulation and coding scheme may be especially important in the case of TDD with ACK/NAK bundling. Conversely, the eNB may elect not to schedule the downlink of data in the first subframe.

In many embodiments it may be advisable for the constraint intervals to be generally unchanging. This may enable the conservation of processing and signaling resources. It may also be preferable to configure eNBs to schedule constraint intervals so as to provide an optimal distribution of serving time across the controlled transmission points.

In accordance with this disclosure, a reconfiguration of CoMP constraint intervals can be done via RRCs (Radio Resource Control), layer 2 controls, or a combination thereof. As an example, an RRC may provide 4 possible values for constraint intervals, and a 2-bit field in a transmission sent on the PDCCH indicates which of the 4 has been adopted.

Furthermore, an eNB can schedule periodic channel state information feedback or trigger aperiodic CSI feedback so that the set of subframes described in the resulting CSI measurements do not coincide with the timing of a transmission point switch.

Additionally, an eNB may infer different types of CSI reporting based on whether a cell switch is allowed or prohibited during the corresponding reference subframe. For instance, rank reports may be scheduled to report on subframes not under cell switching, while subband reports may report on subframes under cell switching.

Regardless of whether subframe constraints are placed on CSI reporting, a UE's performance may further be improved in accordance with aspects of the present disclosure through an analysis of past UE scheduling history and current operating conditions. Such analysis may be used to predict a UE's next possible serving cell(s), and to take appropriate action based on the prediction.

If the prediction is correct, performance benefits may be achieved through improved timing estimation using reference signals from the next set of serving cells. If the prediction is wrong, the UE may make an improved prediction following the next subframe. Furthermore, constraint intervals may help UEs in other ways, such as by enabling improved reporting designs.

In accordance with an aspect, an indication may be introduced to convey to the UE an upcoming cell switch, or a transmission point to which an upcoming switch will be made. The indication of an upcoming switch may be conveyed over the PDCCH by using new bits or reserved bits. This type of communication would allow a range of possible switching messages based upon the number of bits used.

Additionally, some other downlink signaling could be used to convey the message. For example, a UE may be warned that upon reception of the PDCCH, a cell switch may be expected to happen at a declared subsequent time. The time could be a fixed time that is used on all occasions and known throughout the system, or could be a time that is configured through RRC.

Alternatively, the switching message may convey a certain granularity condition, such as the condition that switching can only occur at a declared frame boundary. When future switching is indicated to a UE, in most cases it may still be the responsibility of the controlling eNB to command the switch when the switching time arrives.

By providing an anticipatory message of the transmission point to which a UE will be switched, a tradeoff made be made between cell switching flexibility and the related physical layer performance (including time tracking reliability, channel estimation, etc.).

In accordance with this disclosure, it may be highly beneficial to have the controlling eNB and UE synchronized with regards to the timing of transmissions sent from the serving transmission point. This alignment may be achieved by utilizing the System Frame Number in combination with the subframe index, the configured subframe constraint intervals, as well as UE specific parameters.

For instance, suppose the subframe constraint interval is the same for all the cells and is equal to N subframes. In this case, the start subframe of a new serving cell(s) can be given by:

Mod(10*SFN+subframe_index−Δ,N)=0,

where Δ is a UE-specific offset.

When the subframe constraint interval is not constant for all transmission points, it may become difficult to keep an eNB and UE in sync. For instance, suppose that there are 2 available transmission points in the network, and the subframe constraint interval for the second transmission point (N_{—}2) is longer than the interval for the first transmission point (N_{—}1). Accordingly, it can be shown that:

Mod(10*SFN+subframe_index−Δ,N_{—}2)=0,

and thus the frame zero may be a start frame of a new serving cell;

Furthermore, within the N_{—}2 subframes, if the UE starts with the second serving cell, the entire N_{—}2 subframes are for the second cell, but if the commences with the first serving cell, switching to the second cell may happen after N_{—}1 subframes (within the N_{—}2 subframes). For example, if N_{—}1=5 subframes, and N_{—}2=10 subframes, then a cell switch may be anticipated to occur on every 10^{th} subframes.

However, if the UE starts with cell 1, a cell switch may happen at the 6^{th} subframe (to cell 2). That is, the UE will be served during subframes 0-4 by cell 1; and during subframes 5-9 by cell 2. Note that, at subframe 10, cell switching may happen. The uncertainty illustrated by this example is one reason that it may be simpler, and therefore, preferable, to keep constraint lengths equivalent across all transmission points.

The concept of restricting the switching of serving transmission points may also be useful from the perspective of uplink operation. For example, if a UE derives uplink timing from the timing of a downlink transmission, then switching of the serving transmission point(s) on the downlink may impact uplink timing as well.

Restricting the instances in which such a switching of transmission points may take place, as discussed supra, may therefore lead to better control of the uplink timing as well. This may be beneficial from the perspective of uplink power control, sounding reference signal (SRS) transmission, as well as uplink operation in general.

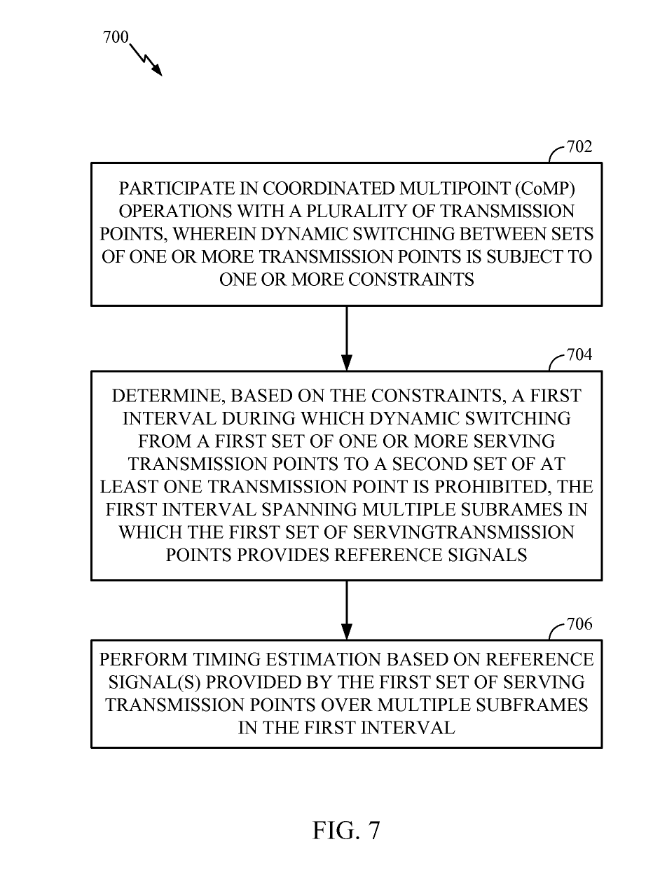

FIG. 7 illustrates example CoMP multi-point switching operations 700 by a UE in accordance with this disclosure. The operations 700 begin, at 702, with the UE participating in CoMP operations with a plurality of transmission points, wherein dynamic switching between sets of one or more serving transmission points is subject to one or more constraints.

At 704, the UE determines, based on the constraints, a first interval during which dynamic switching from a first set of at least one serving transmission point to a second set of at least one serving transmission point is prohibited, the first interval spanning multiple subframes in which the first serving transmission point provides reference signals (RS). At 706, the UE performs timing estimation based on reference signals (RS) provided by the first set of serving transmission points over multiple subframes in the first interval.

The operations shown in FIG. 7 may be performed by any suitable means. For example, the operations may be performed by one or more of processor(s) 358, 380, 364, and/or 386 of UE 120 (shown in FIG. 3) executing various algorithms described herein.

FIG. 8 illustrates example CoMP multi-point switching operations 800 that may be performed, for example, by a base station (e.g., a controlling eNB) in accordance with this disclosure.

The operations 800 begin, at 802, with the eNB determining, based on one or more constraints, a first interval during which dynamic switching from a first set of at least one serving transmission point to a second set of at least one serving transmission point is prohibited, the first interval spanning multiple subframes in which the first serving transmission point provides reference signals (RS) to a user equipment (UE). At 804, the eNB dynamically switches from the first set of at least one serving transmission point serving the UE to the second set of at least one transmission point serving the UE only after the first interval.

The operations shown in FIG. 8 may be performed by any suitable means. For example, the operations may be performed by one or more of processor(s) 320, 330, 338, 340, and/or scheduler 344 of eNB 110 (shown in FIG. 3) executing various algorithms described herein.

Those of skill in the art would understand that information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits and algorithm steps described in connection with the disclosure herein may be implemented as electronic hardware, computer software, or combinations of both. To clearly illustrate this interchangeability of hardware and software, various illustrative components, blocks, modules, circuits and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components or any combination thereof designed to perform the functions described herein. A general-purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM or any other form of storage medium known in the art. An exemplary storage medium is coupled to the processor such that the processor can read information from, and/or write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal Generally, where there are operations illustrated in Figures, those operations may have corresponding counterpart means-plus-function components with similar numbering.

In one or more exemplary designs, the functions described may be implemented in hardware, software, firmware or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for wireless communications by a user equipment (UE), comprising:
participating in coordinated multipoint (CoMP) operations with a plurality of transmission points, wherein dynamic switching between sets of one or more serving transmission points is subject to one or more constraints;
determining, based on the constraints, a first interval during which dynamic switching from a first set of at least one serving transmission point to a second set of at least one serving transmission point is prohibited, the first interval spanning multiple subframes in which the first serving transmission point provides reference signals (RS); and
performing timing estimation based on reference signals (RSs) provided by the first set of serving transmission points over multiple subframes in the first interval.

2. The method of claim 1, wherein the RSs comprise non-common reference signals (non-CRS) reference signals.

3. The method of claim 1, wherein performing timing estimation comprises:
performing initial timing estimation based on RS received in a first subframe in the first interval; and
updating the timing estimation based on RS received in at least a second subframe in the first interval.

4. The method of claim 1, further comprising updating Fast Fourier Transform (FFT) timing based on RS received in at least a second subframe in the first interval.

5. The method of claim 1, wherein the first set of serving transmission points comprises multiple serving transmission points.

6. The method of claim 1, further comprising:
determining that a switch has occurred to the second set of one or more serving transmission points;
determining a second interval during which dynamic switching from the second set of one or more serving transmission points to a third set of one or more transmission points is prohibited; and
performing timing estimation based on reference signals (RSs) provided by the second set of serving transmission points over multiple subframes in the second interval.

7. The method of claim 1, wherein the constraints limit switching between sets of serving transmission points to a per-frame basis, each frame comprising a predetermined number of subframes.

8. The method of claim 1, further comprising receiving signaling indicating a duration of the first interval.

9. The method of claim 8, wherein the signaling is conveyed in a physical downlink control channel (PDCCH).

10. The method of claim 1, wherein different sets of serving transmission points have different corresponding intervals during which dynamic switching between sets of serving transmission points is prohibited.

11. The method of claim 1, wherein the constraints define different intervals during which dynamic switching is prohibited, with the duration of the different intervals dependent on at least one of:
subframe configuration or downlink subframe bundling window size.

12. The method of claim 1, further comprising:
receiving signaling indicating an upcoming switch to a second set of one or more serving transmission points.

13. The method of claim 1, further comprising:
analyzing past scheduling history and current operating conditions;
predicting a switch to the second set of serving cells based on the analysis; and
taking action based on the prediction.

14. The method of claim 13, wherein taking action comprises performing timing estimation based on reference signals transmitted from the second set of serving cells.

15. A method for coordinated multipoint (CoMP) operation, comprising:
determining, based on one or more constraints, a first interval during which dynamic switching from a first set of at least one serving transmission point to a second set of at least one serving transmission point is prohibited, the first interval spanning multiple subframes in which the first serving transmission point provides reference signals (RS) to a user equipment (UE); and
dynamically switching from the first set of at least one serving transmission point serving the UE to the second set of at least one transmission point serving the UE only after the first interval.

16. The method of claim 15, wherein the RSs comprise non-common reference signals (non-CRS) reference signals.

17. The method of claim 15, wherein the first set of serving transmission points comprises multiple serving transmission points.

18. The method of claim 15, wherein the constraints limit switching between sets of serving transmission points to a per-frame basis, each frame comprising a predetermined number of subframes.

19. The method of claim 15, further comprising signaling, to the UE, an indication of a duration of the first interval.

20. The method of claim 19, wherein the signaling is conveyed in a physical downlink control channel (PDCCH).

21. The method of claim 15, wherein different sets of serving transmission points have different corresponding intervals during which dynamic switching between sets of serving transmission points is prohibited.

22. The method of claim 15, wherein the constraints define different intervals during which dynamic switching is prohibited, with the duration of the different intervals dependent on at least one of:
subframe configuration or downlink subframe bundling window size.

23. The method of claim 15, further comprising:
signaling, to the UE, an indication of an upcoming switch to a second set of one or more serving transmission points.

24. The method of claim 15, further comprising:
configuring the UE for channel state information (CSI) reporting in a manner that attempts to avoid having as reference subframes for CSI measurement subframes in which dynamic switching between sets of serving transmission points is not prohibited.

25. The method of claim 24, further comprising:
differentiating between CSI reporting types on the basis of whether or not dynamic switching between sets of serving transmission points was prohibited in the corresponding reference subframes.

26. An apparatus for wireless communications, comprising:
means for participating in coordinated multipoint (CoMP) operations with a plurality of transmission points, wherein dynamic switching between sets of one or more serving transmission points is subject to one or more constraints;
means for determining, based on the constraints, a first interval during which dynamic switching from a first set of at least one serving transmission point to a second set of at least one serving transmission point is prohibited, the first interval spanning multiple subframes in which the first serving transmission point provides reference signals (RS); and
means for performing timing estimation based on reference signals (RSs) provided by the first set of serving transmission points over multiple subframes in the first interval.

27. The apparatus of claim 26, wherein the RSs comprise non-common reference signals (non-CRS) reference signals.

28. The apparatus of claim 26, wherein the means for performing timing estimation comprises:
means for performing initial timing estimation based on RS received in a first subframe in the first interval; and
means for updating the timing estimation based on RS received in at least a second subframe in the first interval.

29. The apparatus of claim 26, further comprising means for updating Fast Fourier Transform (FFT) timing based on RS received in at least a second subframe in the first interval.

30. The apparatus of claim 26, wherein the first set of serving transmission points comprises multiple serving transmission points.

31. The apparatus of claim 26, further comprising:
means for determining that a switch has occurred to the second set of one or more serving transmission points;
determining a second interval during which dynamic switching from the second set of one or more serving transmission points to a third set of one or more transmission points is prohibited; and
means for performing timing estimation based on reference signals (RSs) provided by the second set of serving transmission points over multiple subframes in the second interval.

32. The apparatus of claim 26, wherein the constraints limit switching between sets of serving transmission points to a per-frame basis, each frame comprising a predetermined number of subframes.

33. The apparatus of claim 26, further comprising means for receiving signaling indicating a duration of the first interval.

34. The apparatus of claim 33, wherein the signaling is conveyed in a physical downlink control channel (PDCCH).

35. The apparatus of claim 26, wherein different sets of serving transmission points have different corresponding intervals during which dynamic switching between sets of serving transmission points is prohibited.

36. The apparatus of claim 26, wherein the constraints define different intervals during which dynamic switching is prohibited, with the duration of the different intervals dependent on at least one of:
subframe configuration or downlink subframe bundling window size.

37. The apparatus of claim 26, further comprising:
means for receiving signaling indicating an upcoming switch to a second set of one or more serving transmission points.

38. The apparatus of claim 26, further comprising:
means for analyzing past scheduling history and current operating conditions;
means for predicting a switch to the second set of serving cells based on the analysis; and
means for taking action based on the prediction.

39. The apparatus of claim 38, wherein the means for taking action comprises performing timing estimation based on reference signals transmitted from the second set of serving cells.

40. An apparatus for wireless communications capable of coordinated multipoint (CoMP) operation, comprising:
means for determining, based on one or more constraints, a first interval during which dynamic switching from a first set of at least one serving transmission point to a second set of at least one serving transmission point is prohibited, the first interval spanning multiple subframes in which the first serving transmission point provides reference signals (RS) to a user equipment (UE); and
means for dynamically switching from the first set of at least one serving transmission point serving the UE to the second set of at least one transmission point serving the UE only after the first interval.

41. The apparatus of claim 40, wherein the RSs comprise non-common reference signals (non-CRS) reference signals.

42. The apparatus of claim 40, wherein the first set of serving transmission points comprises multiple serving transmission points.

43. The apparatus of claim 40, wherein the constraints limit switching between sets of serving transmission points to a per-frame basis, each frame comprising a predetermined number of subframes.

44. The apparatus of claim 40, further comprising means for signaling, to the UE, an indication of a duration of the first interval.

45. The apparatus of claim 44, wherein the signaling is conveyed in a physical downlink control channel (PDCCH).

46. The apparatus of claim 40, wherein different sets of serving transmission points have different corresponding intervals during which dynamic switching between sets of serving transmission points is prohibited.

47. The apparatus of claim 40, wherein the constraints define different intervals during which dynamic switching is prohibited, with the duration of the different intervals dependent on at least one of:
subframe configuration or downlink subframe bundling window size.

48. The apparatus of claim 40, further comprising:
means for signaling, to the UE, an indication of an upcoming switch to a second set of one or more serving transmission points.

49. The apparatus of claim 40, further comprising:
means for configuring the UE for channel state information (CSI) reporting in a manner that attempts to avoid having as reference subframes for CSI measurement subframes in which dynamic switching between sets of serving transmission points is not prohibited.

50. The apparatus of claim 49, further comprising:
means for differentiating between CSI reporting types on the basis of whether or not dynamic switching between sets of serving transmission points was prohibited in the corresponding reference subframes.

51. An apparatus for wireless communications, comprising:
at least one processor configured to participate in coordinated multipoint (CoMP) operations with a plurality of transmission points, wherein dynamic switching between sets of one or more serving transmission points is subject to one or more constraints, determine, based on the constraints, a first interval during which dynamic switching from a first set of at least one serving transmission point to a second set of at least one serving transmission point is prohibited, the first interval spanning multiple subframes in which the first serving transmission point provides reference signals (RS), and perform timing estimation based on reference signals (RSs) provided by the first set of serving transmission points over multiple subframes in the first interval; and
a memory coupled with the at least one processor.

52. An apparatus for wireless communications, comprising:
at least one processor configured to determine, based on one or more constraints, a first interval during which dynamic switching from a first set of at least one serving transmission point to a second set of at least one serving transmission point is prohibited, the first interval spanning multiple subframes in which the first serving transmission point provides reference signals (RS) to a user equipment (UE) and dynamically switch from the first set of at least one serving transmission point serving the UE to the second set of at least one transmission point serving the UE only after the first interval; and
a memory coupled with the at least one processor

53. A computer program product comprising a computer readable medium having instructions stored thereon, the instructions executable by one or more processors for:
participating in coordinated multipoint (CoMP) operations with a plurality of transmission points, wherein dynamic switching between sets of one or more serving transmission points is subject to one or more constraints;
determining, based on the constraints, a first interval during which dynamic switching from a first set of at least one serving transmission point to a second set of at least one serving transmission point is prohibited, the first interval spanning multiple subframes in which the first serving transmission point provides reference signals (RS); and
performing timing estimation based on reference signals (RSs) provided by the first set of serving transmission points over multiple subframes in the first interval.

54. A computer program product comprising a computer readable medium having instructions stored thereon, the instructions executable by one or more processors for:
determining, based on one or more constraints, a first interval during which dynamic switching from a first set of at least one serving transmission point to a second set of at least one serving transmission point is prohibited, the first interval spanning multiple subframes in which the first serving transmission point provides reference signals (RS) to a user equipment (UE); and
dynamically switching from the first set of at least one serving transmission point serving the UE to the second set of at least one transmission point serving the UE only after the first interval.
